(19) United States
(12) Patent Application Publication
(10) Pub. No.: US 2020/0384661 A1
(43) Pub. Date: Dec. 10, 2020

(54) Cordless Hair Cutter with Improved Energy Storage

(71) Applicant: Andis Company, Sturtevant, WI (US)

(72) Inventors: Richard J. Tringali, Racine, WI (US); Robert E. Derby, Racine, WI (US)

(21) Appl. No.: 16/895,216

(22) Filed: Jun. 8, 2020

Related U.S. Application Data
(60) Provisional application No. 62/859,557, filed on Jun. 10, 2019.

(51) Int. Cl. B26B 19/38; B26B 19/28; H02K 7/075; H02K 11/00; H01G 11/22; H01G 11/52

(52) U.S. Cl. CPC B26B 19/3873; B26B 19/3846; B26B 19/3853; B26B 19/28; B26B 19/06; H02K 11/0094; H01G 11/22; H01G 11/52; H02K 7/075

(57) ABSTRACT

A hair cutter with an energy storage device is provided. The energy storage device is connected to the motor through a circuit that powers the motor to oscillate a translating blade over a stationary blade. When the hair cutter is operating the energy storage device is discharged. When the energy storage device is completely discharged, the hair cutter is recharged, for example, by connecting the hair cutter to a power outlet. The electrical circuit connects the energy storage device to a voltage and/or current input to charge the energy storage device. The electrical circuit may also transform the input. For example, the circuit may transform an AC input (e.g., 120V, 12 A) to a DC input (e.g., 4.7V-5.5V, 2.5 A) when the energy storage device is a supercapacitor.

### CROSS-REFERENCE TO RELATED PATENT APPLICATION

The present application claims the benefit of and priority to U.S. Provisional Application No. 62/859,557 filed on Jun. 10, 2019, which is incorporated herein by reference in its entirety.

### BACKGROUND OF THE INVENTION

The present invention generally relates to the field of hair cutters. Haircutters include a blade set that has a fixed blade in face-to-face relation with a movable blade. An electric motor drives the movable blade relative to the fixed blade to create a reciprocating motion to move overlapping cutting teeth on the respective blades relative to each other. Shearing action cuts hair located within the teeth when the blades translate. The present disclosure relates specifically to energy storage assemblies used to power the motor during operation.

### SUMMARY OF THE INVENTION

One embodiment of the invention relates to a haircutter powered by a rechargeable, electrical energy storage device. The haircutter includes a handle, a stationary blade, a translating blade, an electric motor, an energy storage device, and a circuit. The handle has an enclosure defining an interior. The stationary blade is fixed to the enclosure and includes a first set of cutting teeth. The translating blade includes a second set of cutting teeth. The translating blade is slidably supported relative to the stationary blade such that the first and second sets of cutting teeth cooperate to cut hair when the translating blade slides relative to the stationary blade. The interior of the handle supports the electric motor. The electric motor has first and second contacts for applying electrical energy to the motor. The motor is fixed to the enclosure and coupled to the translating blade to slide the translating blade relative to the stationary blade when electrical energy is applied to the electric motor. The energy storage device includes first and second electrodes separated by an ion-permeable membrane and an electrolyte. The electrolyte is ionically connected to both electrodes. The circuit connects the contacts to the electrodes to selectively apply electrical energy to the electric motor.

Another embodiment of the invention relates to a haircutter powered by a rechargeable electrical energy storage device. The cutter includes a handle, a stationary blade, a translating blade, an electric motor, an energy storage device, and a circuit. The handle has an enclosure defining an interior. The stationary blade is fixed to the enclosure and includes a first set of cutting teeth. The translating blade includes a second set of cutting teeth. The translating blade is slidably supported relative to the stationary blade such that the first and second sets of cutting teeth cooperate to cut hair when the translating blade slides relative to the stationary blade. The interior of the handle supports the electric motor. The electric motor has first and second contacts for applying electrical energy to the motor. The motor is fixed to the enclosure and coupled to the translating blade to slide the translating blade relative to the stationary blade when electrical energy is applied to the electric motor. The energy storage device is supported within the interior of the handle and includes first and second electrodes separated by an ion-permeable membrane and an electrolyte. The electrolyte ionically connects both electrodes. The energy storage device has an electrical capacitance of at least 100 Farads and a volume less than 2 cubic inches. The super capacitor can have an electrical capacitance of at least 300 Farads and a volume less than 3.5 cubic inches. The circuit connects the contacts to the electrodes to selectively apply electrical energy to the electric motor.

Another embodiment of the invention relates to a wireless hair cutter powered by a rechargeable electrical energy storage device. The cutter includes a handle, a stationary blade, a translating blade, an electric motor, a supercapacitor, and a circuit. The handle has an enclosure defining an interior. The stationary blade is fixed to the enclosure and includes a first set of cutting teeth. The translating blade includes a second set of cutting teeth and is slidably supported relative to the stationary blade such that the first and second sets of cutting teeth cooperate to cut hair when the translating blade slides relative to the stationary blade. The electric motor has first and second contacts for applying electrical energy to the motor. The motor is fixed to the enclosure and coupled to the translating blade to slide the translating blade relative to the stationary blade when electrical energy is applied to the electric motor. The supercapacitor is supported within the interior and has an energy storage capacity per unit volume at least 12 times greater than an electrolytic capacitor. The supercapacitor includes first and second electrodes. The circuit connects the contacts to the electrodes to selectively apply electrical energy to the electric motor.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a hair cutter, according to an exemplary embodiment.

FIG. 2 is a view of the bottom or operating end of hair cutter of FIG. 1.

FIG. 3 is a perspective view of the haircutter of FIG. 1 with the cover or upper housing removed, according to an exemplary embodiment.

FIG. 4 is a perspective view of the haircutter of FIG. 1, with both the upper housing and motor cover removed, according to an exemplary embodiment.

FIG. 5 is a perspective view of the operable connection of a motor, a drive assembly, and a blade assembly, according to an exemplary embodiment.

FIG. 6 is a side view of the operable connection between the motor, the drive assembly, and the blade assembly, taken from the perspective of 6-6 in FIG. 5.

FIG. 7 is a top view of the operable connection between the motor, the drive assembly, and the blade assembly.

FIG. 8 is a perspective view of the motor, the drive assembly, and the blade assembly of FIG. 5; the drive assembly is shown in a partially exploded view.

FIG. 9 is a cross-sectional view of the motor, the drive assembly, and the blade assembly of FIGS. 5-8, taken along line 9-9 of FIG. 7.

FIG. 10 is an exploded view of the blade assembly of FIG. 5.

FIG. 11 is a circuit diagram for a rechargeable, electrical energy storage capacitive device, according to an exemplary embodiment.

FIG. 12 is a component-part list of electrical parts in the circuit of FIG. 11, according to an exemplary embodiment.

### DETAILED DESCRIPTION

Referring generally to the figures, various embodiments of a cordless hair cutter 10 are shown. A motor 54 powers a translating blade 28 that oscillates or translates over a stationary blade 26. An energy storage device, which for the present invention is a supercapacitor, is used to store energy that can later be used to power the motor. The term “hair cutter” is inclusive, and refers to any hair grooming device, including, but not limited to, a hair trimmer, a hair clipper, or any other hair cutting or hair grooming device. In addition, the hair grooming device can be suitable for a human, animal, or any other suitable living or inanimate object having hair.

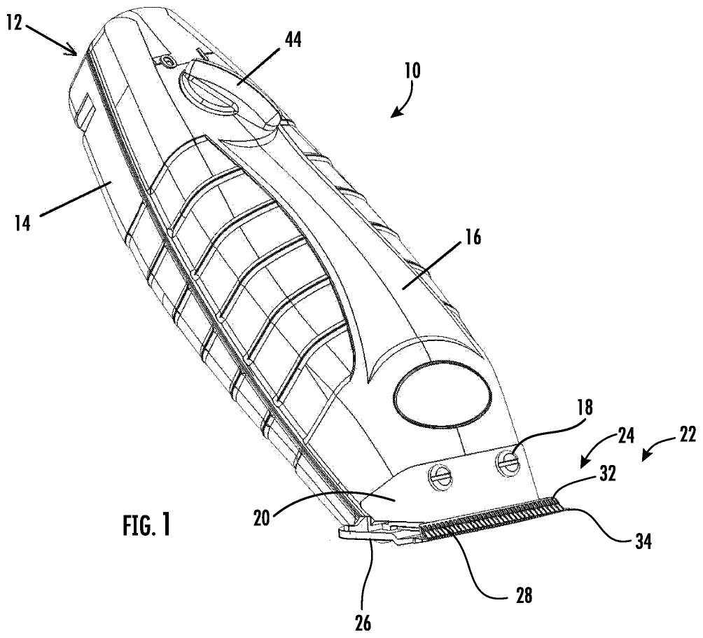

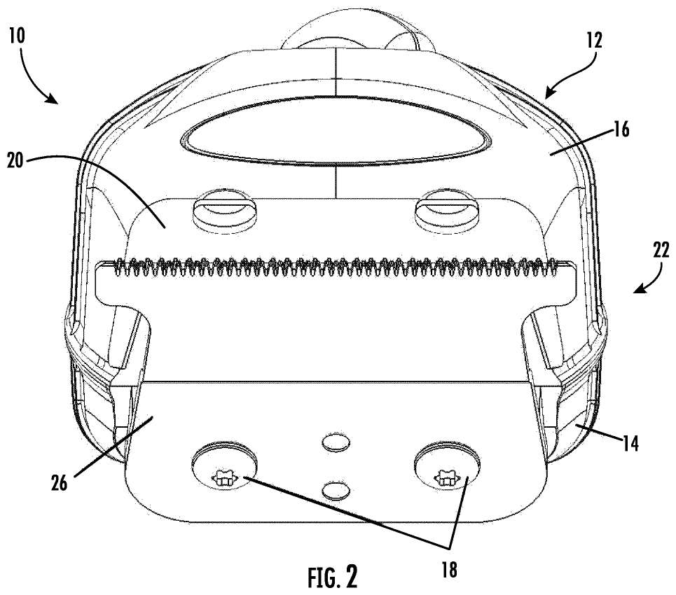

Referring to the figures, FIG. 1 illustrates an embodiment of a haircutter 10 having a handheld housing, handle, or body 12. Body 12 is defined by a first or lower housing 14 and a removable cover or upper housing 16. Lower housing 14 and upper housing 16 are coupled by a plurality of fasteners 18 (e.g., bolts, screws, etc.). Fasteners 18 also couple other components of hair cutter 10. Fasteners 18 may couple a shield 20 to the blade assembly 22. For example, the lower housing 14 and upper housing 16 are configured to snap together to reduce or eliminate the need for fasteners 18. A blade assembly 22 is coupled to a first or cutting end 24 of the body 12. The blade assembly 22 includes a lower outer blade or stationary blade 26 and an upper or inner blade or translating blade 28. The translating blade 28 is supported on a surface of the stationary blade 26 and is movable with respect to the stationary blade 26. The translating blade 28 can include a drive socket configured to engage a reciprocating or oscillating drive assembly 30 (shown in FIG. 2). Translating blade 28 couples to other structures that engage the reciprocating or oscillating drive assembly 30. Drive assembly 30 is configured to generate oscillating or reciprocating movement of blade assembly 22 to facilitate cutting hair.

Blade assembly 22 is coupled to cutting end 24 of hair cutter 10. Translating blade 28 includes translating cutting teeth 32 (e.g., a first set, inner, or upper cutting teeth). Stationary blade 26 includes stationary cutting teeth 34 (e.g., a second set, outer, or lower cutting teeth). As translating blade 28 oscillates over stationary blade 26, translating cutting teeth 32 cooperate with stationary cutting teeth 34 to cut hair.

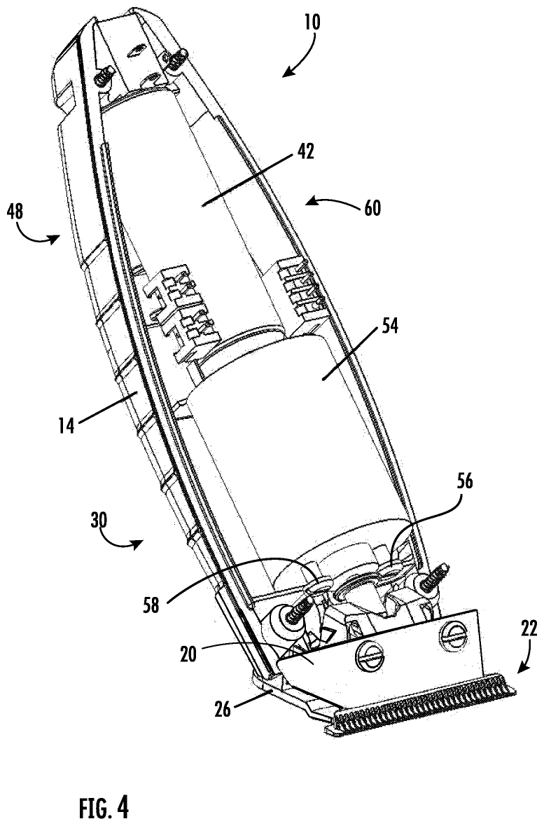

FIG. 2 shows an end view of haircutter 10. From this perspective, the operating end or blade assembly 22 including a blade assembly 22 is shown from an end view of stationary blade 26. Fasteners 18 couple stationary blade 26 to body 12 (e.g., lower housing 14 and/or upper housing 16). Shield 20 covers a top of blade assembly 22 to prevent hair and/or other debris from entering the drive assembly 30 (FIGS. 4-14).

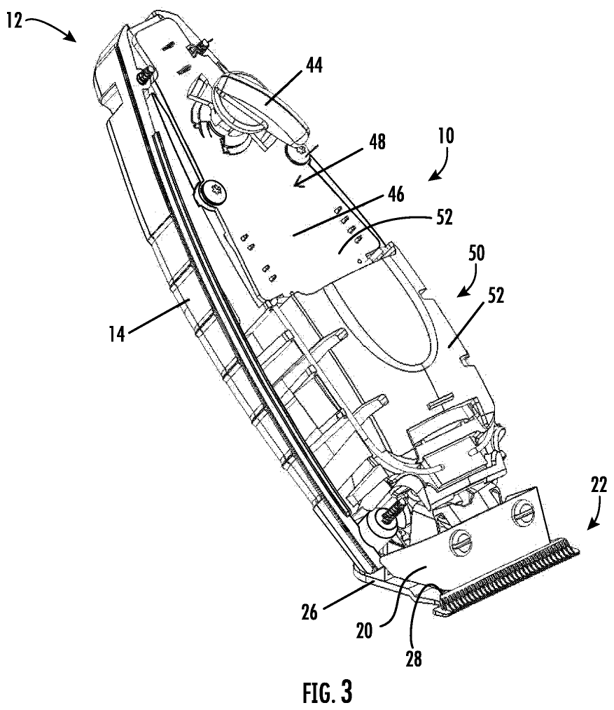

FIG. 3 shows a perspective view of hair cutter 10 with a cover or upper housing 16 removed. In this configuration, body 12 is incomplete and includes only lower housing 14. Switch 44 is shown at a location above where upper housing 16 would be situated. Switch 44 controls supercapacitor 42 (FIG. 4) to power circuit 46 and drive a power assembly 48. Power assembly 48 supplies power from supercapacitor 42 to motor assembly 50. Motor assembly 50 is coupled to blade assembly 22. Motor assembly 50 is captured between lower housing 14 and motor cover 52. Shield 20 and stationary blade 26 cooperate to prevent hair or other debris from entering blade assembly 22 and preventing the translating motion of translating blade 28.

FIG. 4 shows a perspective view of hair cutter 10 with both upper housing 16 and motor cover 52 removed. Haircutter 10 includes drive assembly 30 and power assembly 48. As illustrated, power assembly 48 electrically connects electrochemical capacitor or supercapacitor 42 to an electric motor 54 in drive assembly 30. In the illustrated embodiment, the lower housing 14 contains drive assembly 30 with electric motor 54. Electric motor 54 may be disposed anywhere within body 12.

As shown in FIG. 4, electric motor 54 is a brushless magnetic motor 54. However, in other embodiments, electric motor 54 can be a pivot motor 54, a linear motor 54, a rotary motor 54, or any other suitable motor 54 for generating oscillating or reciprocating movement of blade assembly 22. In various embodiments, electric motor 54 may be a rotating brushless DC motor 54 or a linear brushless DC motor 54, or another direct current electric motor 54 or rotating electric motor 54.

Electric motor 54 has a first contact 56 (e.g., positive contact) and a second contact 58 (e.g., negative contact). The first contact 56 and second contact 58 receive electrical energy from supercapacitor 42 and apply it to electric motor 54. In one embodiment, electric motor 54 is a direct current motor 54, and motor assembly 50 includes a winding, magnets, a commutator, and brushes. In various embodiments, the winding has first and second terminals (e.g., coupled to first contact 56 and second contact 58) and a permanent magnet. The permanent magnets and the terminals are coupled to first and second brushes at the respective terminals of the winding. The first brush being coupled to the first contact 56 and the second brush being coupled to the second contact 58. For example, the electric motor 54 is a linear, translating motor 54 having a winding and an armature with one of the winding and the armature being fixed to the enclosure and the other of the winding and the armature being coupled to the translating blade 28. Motor 54 oscillates translating blade 28 over stationary blade 26.

For example, electric motor 54 is supported within a volume or interior 60 of the handle or body 12. Electric motor 54 has first contact 56 and second contact 58 to receive electrical energy from supercapacitor 42. Motor 54 revolves an output or drive shaft 62 coupled to drive assembly 30. Motor 54 is fixed within interior 60 of the enclosure and coupled to translating blade 28 to slide translating blade 28 relative to stationary blade 26 when electrical energy is applied to electric motor 54.

As shown, supercapacitor 42 is positioned within body 12. A switch 44 is positioned on an external part of body 12 (as illustrated in FIG. 1 switch 44 is on upper housing 16, but may be disposed on lower housing 14 or a joint between lower housing 14 and upper housing 16). Switch 44 completes a circuit to power drive assembly 30 (FIGS. 4-9) “on” or “off.” Switch 44 is user operable; for example, it can be actuated by fingers and/or a thumb of the user. Positioning switch 44 into the “on” position provides electrical power from supercapacitor 42 to drive assembly 30. Positioning switch 44 into the “off” position terminates the electrical power from supercapacitor 42 to drive assembly 30.

Supercapacitor 42 uses an electrostatic double-layer capacitance and electrochemical pseudo-capacitance, and therefore may not include a conventional solid dielectric. The electrostatic double-layer capacitance and/or electrochemical pseudo-capacitance both contribute to the total capacitance of the supercapacitor 42. Thus, supercapacitor 42 includes two electrodes separated by an ion-permeable membrane, typically called a separator. An electrolyte ionically connects both the electrodes. When the electrodes are polarized by an applied voltage, ions in the electrolyte form electric double layers of opposite polarity to the electrode's polarity, for example, positively polarized electrodes will have a layer of negative ions at the electrode/electrolyte interface along with a charge-balancing layer of positive ions adsorbing onto the negative layer. The opposite is true for the negatively polarized electrode.

Depending on the electrode material and/or surface shape, some ions can permeate the double layer. These ions are specifically adsorbed ions that contribute to the total capacitance of the supercapacitor 42 (e.g., with pseudo-capacitance). Applicant has found that supercapacitors 42 have an energy density storage sufficient to provide a supercapacitor 42 with a volume able to fit within a cordless hair cutter 10 and also able to provide a sufficient amount of energy to operate a cordless hair cutter 10 for a useful amount of time. The supercapacitors 42 are recharged between hair cutting operations.

Supercapacitor 42 is rechargeable and has a capacitance of at least 100 Farads. In various embodiments, supercapacitor 42 has a capacitance of at least 120 Farads, specifically a capacitance of at least 150 Farads, specifically a capacitance of at least 200 Farads, specifically a capacitance of at least 300 Farads, and more specifically a capacitance of at least 350 Farads. Supercapacitor 42 includes first and second electrodes separated by an ion-permeable membrane and an electrolyte. The electrolyte ionically connects the first and second electrodes making the supercapacitor 42 rechargeable.

In various embodiments, supercapacitor 42 has a volume of less than 3.5 cubic inches, specifically less than 2.5 cubic inches, specifically less than 2 cubic inches, specifically less than 1.5 cubic inches, and more specifically less than 1 cubic inch. For example, in various embodiments supercapacitor 42 has a volume of 3.18±0.2 cubic inches, 1.96±0.2 cubic inches, 1.3±0.2 cubic inches, or 0.98±0.2 cubic inches. Supercapacitor 42 can be cylindrical.

In various embodiments, cylindrical supercapacitor 42 has a cross-sectional diameter of less than 1.5 inches, specifically less than 1.3 inches, and more specifically less than 1 inch. For example, in various embodiments supercapacitor 42 has a cross-sectional diameter of 1.3±0.2 inches, 0.88±0.2 inches, or 0.72±0.2 inches. In various embodiments, supercapacitor 42 has a length of less than 2.5 inches, specifically less than 2.2 inches, and more specifically less than 2 inches. For example, in various embodiments supercapacitor 42 has a length of 2.4±0.2 inches, 2.04±0.2 inches, or 1.8±0.2 inches.

In a specific embodiment, hair cutter 10 includes one cylindrical supercapacitor 42 that is rechargeable and has a capacitance of at least 120 Farads, a diameter of 0.88±0.2 inches, a length of 2.04±0.2 inches, and a volume of 1.3±0.2 inches. In another specific embodiment, hair cutter 10 includes two cylindrical supercapacitors 42 that are rechargeable and each have a capacitance of at least 100 Farads. The two supercapacitors 42 each have a diameter of 0.72±0.2 inches and a length of 2.4±0.2 inches, resulting in two cylinders each with a volume of 0.98±0.2 inches. In a specific embodiment, hair cutter 10 includes a rechargeable supercapacitor 42 with a volume of 3.18±0.3 cubic inches and a capacitance of at least 350 Farads.

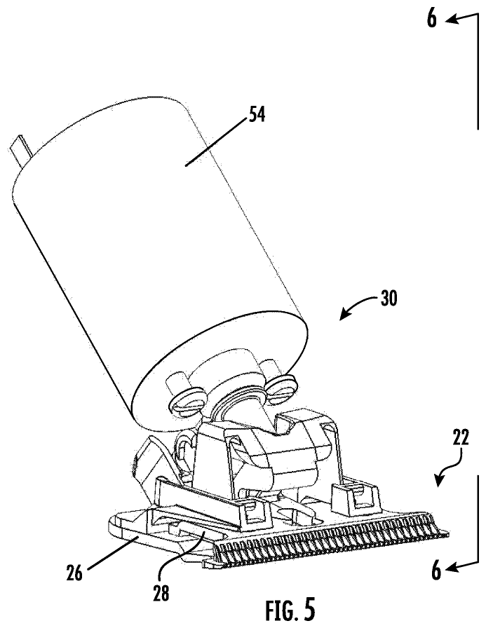

FIG. 5 is a perspective view of the operable connection of motor 54, drive assembly 30, and blade assembly 22. Haircutter 10 is depicted with body 12 (e.g., both lower housing 14 and upper housing 16) removed to illustrate how drive assembly 30 interconnects motor 54 to blade assembly 22. Drive assembly 30 interconnects motor 54 to blade assembly 22. Blade assembly 22 includes a translating blade 28 and a stationary blade 26.

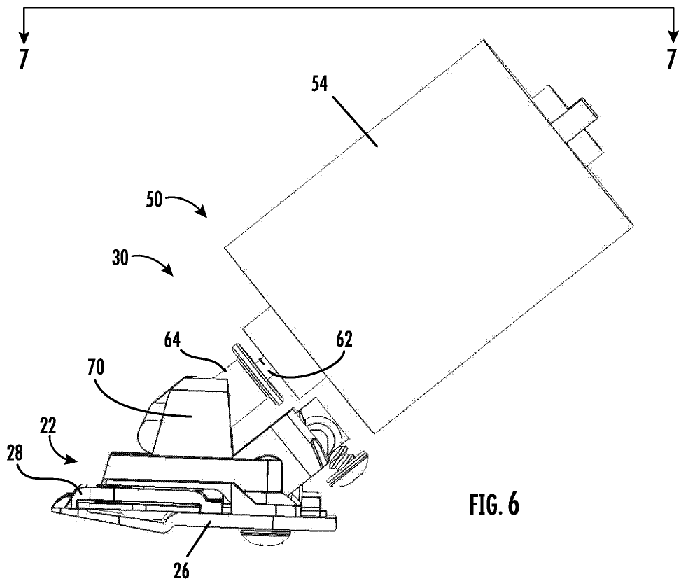

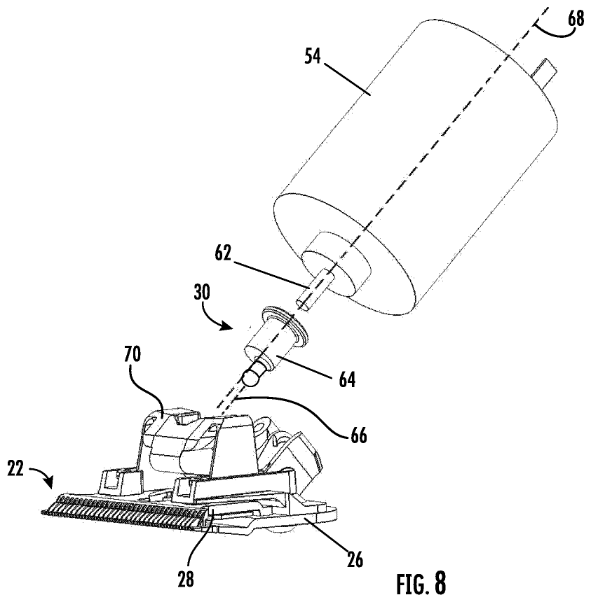

FIG. 6 is a side view of the operable connection between motor 54, drive assembly 30, and blade assembly 22, taken from the perspective of arrow 6-6 in FIG. 5. Motor assembly 50 includes the components for electric motor 54 to rotate an output or drive shaft 62. Drive assembly 30 couples drive shaft 62 to an eccentric drive 64. A longitudinal axis 66 of eccentric drive 64 is offset from the longitudinal axis 68 of drive shaft 62 and motor 54 (FIG. 8). In this way, eccentric drive 64 rotates at a distance about drive shaft 62. Eccentric drive 64 couples the drive shaft 62 to a yoke 70 that couples to eccentric drive 64 and oscillates as eccentric drive 64 rotates about drive shaft 62. Yoke 70 couples drive assembly 30 to blade assembly 22. For example, yoke 70 is rigidly or fixedly coupled to translating blade 28. Thus, as yoke 70 oscillates, translating blade 28 oscillates over stationary blade 26. In this way, translating blade 28 and stationary blade 26 cooperate to cut hair.

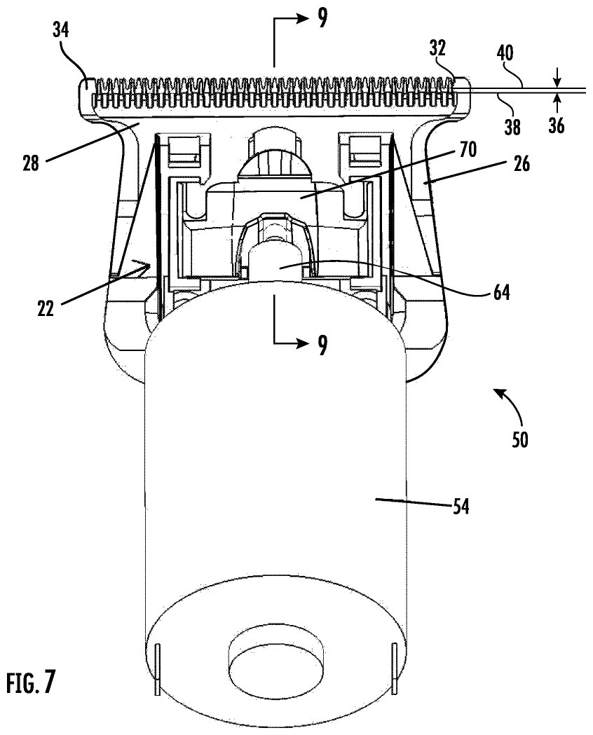

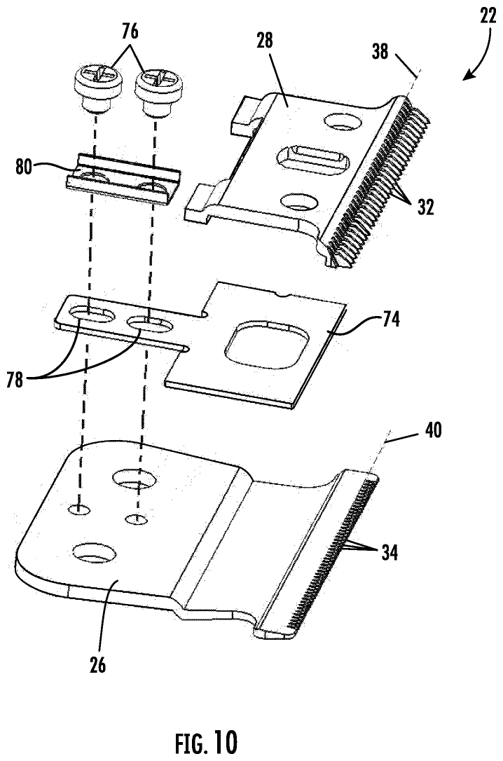

FIG. 7 is a top view of the operable connection between motor assembly 50, drive assembly 30, and blade assembly 22. The position of stationary blade 26 and/or translating blade 28 forms a gap 36. With reference to FIGS. 7 and 10 a view of the gap 36 formed between a translating edge 38 of translating cutting teeth 32 and a stationary edge 40 of stationary cutting teeth 34. Translating edge 38 (FIGS. 7 and 10) is formed at a root or base of the translating cutting teeth 32.

Similarly, stationary edge 40 (FIGS. 7 and 10) is formed at a root or base of the stationary cutting teeth 34. Gap 36 is the distance between translating edge 38 and stationary edge 40. The length of the cut can be controlled with a lever (not shown) or other mechanical system connected to the translating blade 28 and configured to control gap 36.

As gap 36 reduces, a shorter cut is achieved since the translating edge 38, and stationary edge 40 are near or adjacent to one another (e.g., in close proximity). FIG. 1 illustrates blade assembly 22 with a reduced gap 36, configured to make a shorter cut and to form a relatively small gap 36 (e.g., with the stationary blade 26 and translating blade 28 aligned or in close proximity). A larger gap 36 results in a longer cut. As translating blade 28 is repositioned away from stationary blade 26, stationary edge 40 (FIG. 10) and translating edge 38 (FIG. 10) are separated or offset by a greater distance (expanded or not in close proximity), resulting in a larger gap 36 and a longer cut.

As shown, motor 54 couples to drive shaft 62 (FIG. 6) within an eccentric drive 64. As eccentric drive 64 rotates about drive shaft 62, it causes yoke 70 to translate back and forth. Yoke 70 is coupled to translating blade 28, such that as yoke 70 oscillates translating blade 28 oscillates over stationary blade 26. This configuration causes translating cutting teeth 32 to oscillate or translate relative to stationary cutting teeth 34 and cooperate to cut hair.

FIG. 8 is a perspective view of motor 54, drive assembly 30, and blade assembly 22. In this view, drive assembly 30 is partially exploded to show the components that interconnect motor 54 to blade assembly 22. Drive assembly 30 includes drive shaft 62 coupled to motor 54, eccentric drive 64, and yoke 70. As shown, a longitudinal axis 66 of eccentric drive 64 is offset from the longitudinal axis 68 of motor 54 and drive shaft 62. This offset creates a distance between eccentric drive 64 and causes eccentric drive 64 to rotate about longitudinal axis 68 circularly (e.g., in a circular fashion that creates an eccentricity). The eccentric circular rotation about longitudinal axis 68 oscillates a receiver of yoke 70 and translating blade 28 over stationary blade 26.

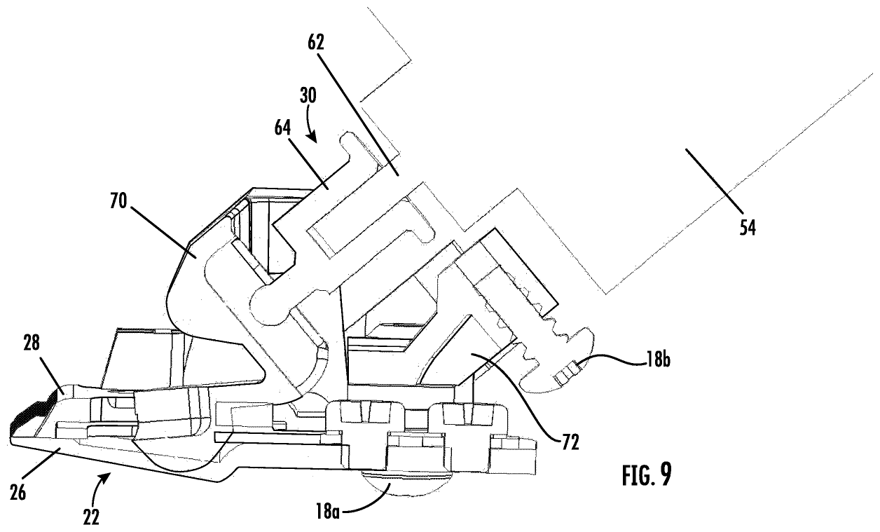

FIG. 9 is a cross-sectional view of motor 54, drive assembly 30, and blade assembly 22, of FIGS. 5-8 taken along line 9-9 of FIG. 7. This view illustrates drive assembly 30, specifically how drive shaft 62 rotates eccentric drive 64 to create an eccentricity that rotates yoke 70. Yoke 70 is coupled to translating blade 28 which translates in response to the eccentric rotation of eccentric drive 64. FIG. 9 illustrates how fasteners 18 fix stationary blade 26 and lower housing 14 to body 12. For example, fasteners 18a couple stationary blade 26 to a blade frame 72 and fastener 18b couples lower housing 14 to blade frame 72, such that stationary blade 26 is fixedly coupled to body 12 of hair cutter 10.

FIG. 10 shows an exploded view of a blade set or blade assembly 22. Blade assembly 22 is located proximate to cutting end 24 of body 12 (FIG. 1). Blade assembly 22 is coupled to body 12 and captured between lower housing 14 and/or upper housing 16 to support the components of blade assembly 22 and interconnect blade assembly 22 to hair cutter 10.

Blade assembly 22 includes an outer, fixed, or stationary blade 26 and an upper, inner, or translating blade 28, and a T-guide 74. Translating blade 28 oscillates over and relative to stationary blade 26. For example, stationary blade 26 is fixed to blade frame 72 that is fixed to body 12 through an interior 60 of hair cutter 10. Stationary blade 26 includes stationary cutting teeth 34 that define stationary edge 40. Stationary blade 26 is coupled to blade assembly 22 (e.g., by screws or fasteners). Any suitable fastener 18 can secure stationary blade 26 to blade assembly 22. Stationary blade 26 includes a set of stationary cutting teeth 34 fixedly supported to body 12. Translating blade 28 includes a set of translating cutting teeth 32 and is slidably supported relative to stationary blade 26. Oscillation of translating blade 28 moves translating cutting teeth 32 relative to stationary cutting teeth 34 to cut hair.

Translating blade 28 is coupled to yoke 70 (e.g., by screws, rivets, or a peg on yoke 70 friction fit into holes on translating blade 28). Translating blade 28 and yoke 70, are biased toward stationary blade 26 by a biasing blade frame 72. Fasteners 18 couple blade frame 72 to stationary blade 26. Yoke 70 receives an eccentric drive 64 coupled to motor 54. The eccentric drive 64 inserts into yoke 70 and causes an oscillating motion from the output of the motor 54. Translating blade 28 and yoke 70 are supported, such that translating blade 28 moves back and forth across stationary blade 26 in response to movement of yoke 70 coupled to eccentric drive 64. Yoke 70 is coupled or attached to translating blade 28. Electric motor 54 includes a rotatable shaft that offsets the rotational output of motor 54 to oscillate translating blade 28 via its interaction with yoke 70.

T-guide 74 positions translating blade 28 relative to stationary blade 26, such that an internal ridge of translating blade 28 slides over the outermost edge (e.g., nearest translating cutting teeth 32). T-guide 74 can move translating blade 28 in a direction perpendicular to the oscillating motion, over stationary blade 26. In this way, T-guide 74 controls gap 36 to provide a longer or shorter cut length. As shown, screws 76 pass through receiving slots 78 of T-guide 74 to permit T-guide 74 to translate in a direction perpendicular to translating edge 38 and stationary edge 40. A bracket 80 may reduce friction between T-guide 74 and screws 76 as T-guide 74 translates to increase or decrease the length of the cut.

Blade frame 72 (FIG. 9) interconnects translating blade 28 to stationary blade 26. In this configuration, blade frame 72 receives a protrusion of translating blade 28 and fixedly couples or attaches stationary blade 26 to body 12. Blade frame 72 and T-guide 74 capture and guide translating blade 28 as it oscillates over stationary blade 26 fixedly coupled to body 12. This configuration stabilizes the forces (e.g., tensile forces) generated by the inner translating blade 28 and outer stationary blade 26. As a result blade assembly 22 provides a more consistent load distribution and more evenly cuts hair. Stabilization reduces the lubrication between the component-parts of blade assembly 22. For example, the materials used to form blade frame 72 may be selected to reduce galling with translating blade 28 as it oscillates relative to stationary blade 26. Stabilization can reduce the energy output demands for motor 54 to oscillate translating blade 28 over stationary blade 26. This stabilization may reduce the size and/or dimensions of supercapacitor 42 and reduce energy demand.

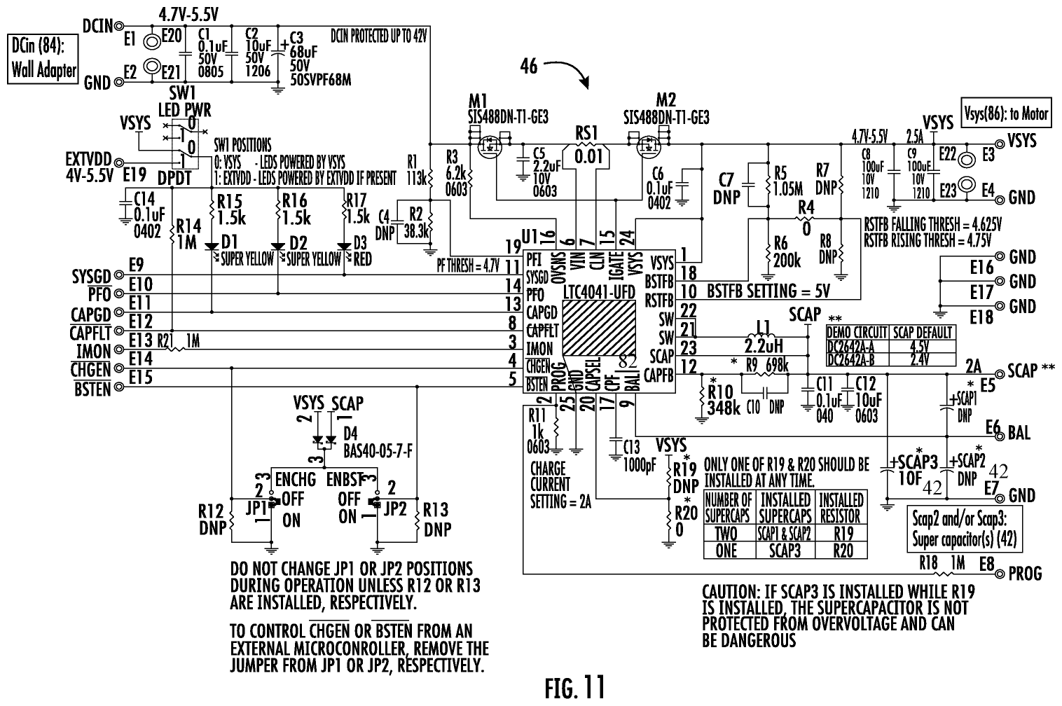

FIG. 11 shows one exemplary embodiment of a supercapacitor circuit 46. Hair cutter 10 includes supercapacitor circuit 46, a supercapacitor backup power manager 82, and one or more energy storage devices or supercapacitors 42. Supercapacitor circuit 46 receives an input/charging voltage and current from input terminals 84 and outputs an output voltage and current to output terminals 86 coupled to motor 54. Supercapacitors 42 include an energy storage device that has first and second electrodes separated by an ion-permeable membrane and an electrolyte. The electrolyte ionically connects and charges both electrodes. Supercapacitor circuit 46 connects the contacts to the electrodes to selectively apply electrical energy to the electric motor 54.

Capacitor circuit 46 provides input terminals 84 to receive an input voltage and output terminals 86 to power a 5V motor 54. The input terminals 84 receives an input voltage from an external source. The external source may be a 5V DC battery and/or 1 or more capacitors. In various embodiments, input terminals 84 receive an input voltage (e.g., from an electrical outlet) that is between 2V and 14V, specifically between 4V and 8V, and more specifically between 4.5V and 5.5V. Input terminals 84 are protected up to 52V. Input terminals 84 may be configured to receive AC or DC currents. Input terminals 84 receive an AC or DC input current amperage (e.g., from an electrical outlet). In various embodiments, input current amperages are between 0.1 A and 5 A, specifically between 1 A and 4 A, and more specifically between 2 A and 3 A.

A supercapacitor backup power manager 82 and/or circuit 46 can connect input terminals 84 to one or more supercapacitors 42 that store energy the input electrical energy for later discharge. Circuit 46 includes a transformer (not shown) to regulate the input voltages and/or current amperages received at input terminals 84 of circuit 46. The transformer interconnects circuit 46 to an external power source, such as an electrical power outlet in the wall of a home or hair cutting studio. For example, the electrical power outlet provides an AC current with a voltage of 120V and an amperage between 10 A-12 A. Circuit 46 runs on different power ratings, as described above. For example, circuit 46 runs on a DC current of 4.7V-5.5V and 2.5 A. Placing a transformer between the power outlet and circuit 46 transforms the voltage and amperage provided to circuit 46 (e.g., from AC 120V, 12 A to DC 5V, 2.5 A).

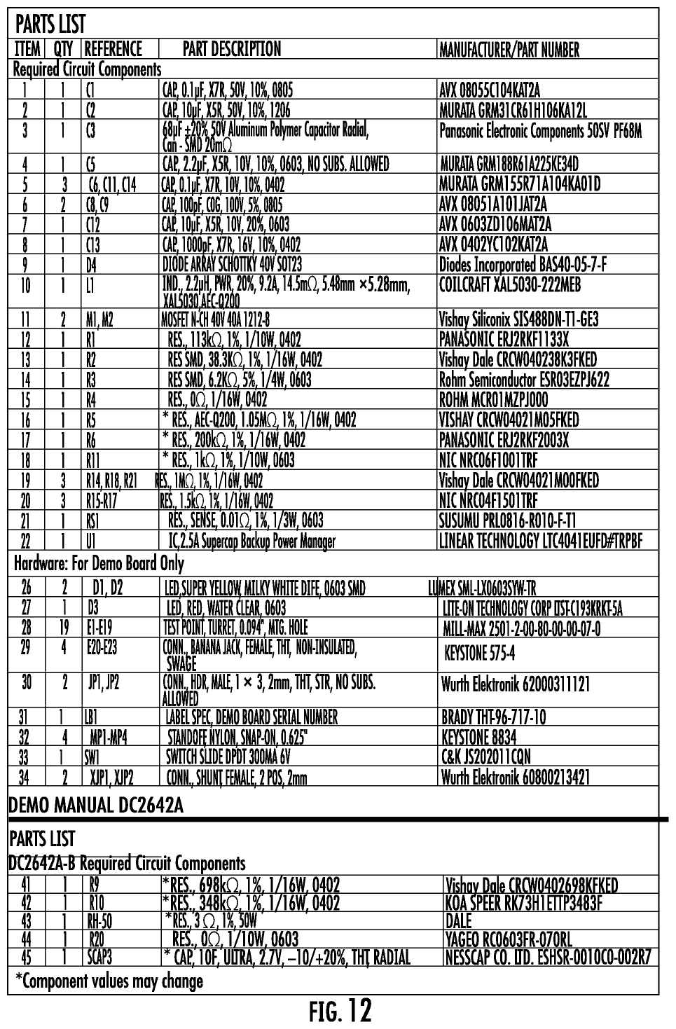

Circuit 46 transforms the input voltage to output terminals 86 to power the motor 54. In various embodiments, the components of circuit 46 are attached in FIG. 12. The components of circuit 46 have the resistance, capacitance, and/or inductance values and tolerances as shown in the table of FIG. 12.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

What is claimed is:

1. A haircutter powered by a rechargeable, electrical energy storage device, the haircutter comprising:
a handle having an enclosure defining an interior;
a stationary blade fixed to the enclosure, the stationary blade including a first set of cutting teeth;
a translating blade including a second set of cutting teeth and slidably supported relative to the stationary blade such that the first set of cutting teeth and the second set of cutting teeth cooperate to cut hair when the translating blade is slid relative to the stationary blade;
an electric motor supported within the interior of the handle and having first and second contacts for applying electrical energy to the electric motor, the electric motor being fixed to the enclosure and coupled to the translating blade to slide the translating blade relative to the stationary blade when electrical energy is applied to the electric motor;
an energy storage device including first and second electrodes separated by an ion-permeable membrane and an electrolyte, the electrolyte ionically connecting both electrodes; and
a circuit for connecting the first and second contacts to the electrodes to selectively apply electrical energy to the electric motor.

2. The haircutter of claim 1, wherein the electric motor is a direct current electric motor including a winding having first and second terminals, permanent magnets, a commutator and first and second brushes coupled to respective terminals of the winding, the first brush being coupled to the first contact and the second brush being coupled to the second contact.

3. The haircutter of claim 2, wherein the electric motor is a rotating motor.

4. The haircutter of claim 3, further comprising a yoke attached to the translating blade and the electric motor includes a rotatable shaft having an offset which couples the electric motor to the translating blade via its interaction with the yoke.

5. The haircutter of claim 2, wherein the electric motor is a linear, translating motor having a winding and an armature with one of the winding and the armature being fixed to the enclosure and the other of the winding and the armature being coupled to the translating blade.

6. The haircutter of claim 1, wherein the electric motor is a rotating brushless DC motor.

7. The haircutter of claim 1, wherein the electric motor is a linear brushless DC motor.

8. The haircutter of claim 1, wherein the energy storage device is a capacitor having a capacitance of at least 100 Farads and a volume less than 2 cubic inches.

9. The haircutter of claim 1, wherein the energy storage device is a cylindrical capacitor having a capacitance of at least 100 Farads, a diameter of less than 1.5 inches and a length of less than 2.5 inches.

10. A haircutter powered by a rechargeable electrical energy storage device, the haircutter comprising:
a handle having an enclosure defining an interior;
a stationary blade fixed to the enclosure, the stationary blade including a first set of cutting teeth;
a translating blade including a second set of cutting teeth and slidably supported relative to the stationary blade such that the first set of cutting teeth and the second set of cutting teeth cooperate to cut hair when the translating blade slides relative to the stationary blade;
an electric motor supported within the interior of the handle and having first and second contacts for applying electrical energy to the electric motor, the electric motor being fixed to the enclosure and coupled to the translating blade to slide the translating blade relative to the stationary blade when electrical energy is applied to the electric motor;
an energy storage device supported within the interior of the handle and including first and second electrodes separated by an ion-permeable membrane and an electrolyte, the electrolyte ionically connecting both electrodes, the energy storage device having a capacitance of at least 100 Farads and a volume less than 3.5 cubic inches; and
a circuit for connecting the first and second contacts to the electrodes to selectively apply electrical energy to the electric motor.

11. The haircutter of claim 10, wherein the energy storage device is a supercapacitor supported within the interior and has an energy storage capacity per unit volume at least 10 times greater than an electrolytic capacitor.

12. The haircutter of claim 10, wherein the electric motor is a direct current electric motor including a winding having first and second terminals, permanent magnets, a commutator and first and second brushes coupled to respective terminals of the winding, the first brush being coupled to the first contact and the second brush being coupled to the second contact.

13. The haircutter of claim 12, wherein the energy storage device has a capacitance of at least 200 Farads and a volume of less than 3.5 cubic inches.

14. The haircutter of claim 13, further comprising a yoke attached to the translating blade and the electric motor includes a rotatable shaft having an offset which couples the electric motor to the translating blade via its interaction with the yoke.

15. The haircutter of claim 12, wherein the electric motor is a linear, translating motor having a winding and an armature with one of the winding and the armature being fixed to the enclosure and the other of the winding and the armature being coupled to the translating blade.

16. The haircutter of claim 10, wherein the electric motor is a rotating brushless DC motor.

17. The haircutter of claim 10, wherein the electric motor is a linear brushless DC motor.

18. The haircutter of claim 10, wherein the energy storage device is a cylindrical capacitor having a diameter of less than 1.5 inches and a length of less than 2.5 inches.

19. A cordless haircutter powered by rechargeable electrical energy storage device, the haircutter comprising:
a handle having an enclosure defining an interior;
a stationary blade fixed to the enclosure, the stationary blade including a first set of cutting teeth;
a translating blade including a second set of cutting teeth and slidably supported relative to the stationary blade such that the first set of cutting teeth and the second set of cutting teeth cooperate to cut hair when the translating blade slides relative to the stationary blade;
an electric motor having first and second contacts for applying electrical energy to the electric motor, the electric motor being fixed to the enclosure and coupled to the translating blade to slide the translating blade relative to the stationary blade when electrical energy is applied to the electric motor;
a supercapacitor supported within the interior and having an energy storage capacity per unit volume at least 10 times greater than an electrolytic capacitor, the supercapacitor including first and second electrodes; and
a circuit for connecting the first and second contacts to the first and second electrodes to selectively apply electrical energy to the electric motor.

20. The cordless haircutter of claim 19, wherein the supercapacitor has a capacitance of at least 100 Farads and includes first and second electrodes separated by an ion-permeable membrane and an electrolyte, the electrolyte ionically connecting the first and second electrodes.
